(19) United States
(12) Patent Application Publication
(10) Pub. No.: US 2011/0087537 A1
(43) Pub. Date: Apr. 14, 2011

(54) REFUND SYSTEM AND METHOD

(76) Inventors: Waleed Hanafi, Singapor (SG); Stefano Bassi, P. Bonneneo (IT)

(21) Appl. No.: 12/920,912

(22) PCT Filed: Apr. 7, 2009
(86) PCT No.: PCT/EP09/02559

§ 371 Date: Dec. 13, 2010

(30) Foreign Application Priority Data
Apr. 8, 2008 (GB) 0806380.2

(51) Int. Cl. G06Q 30/00; G06Q 40/00; G06K 5/00

(52) U.S. Cl. 705/14.34; 705/35; 235/375; 235/380

(57) ABSTRACT

A refund system provides for detections of eligibility of a user for a refund and uses a token to identify purchases and to retrieve the information in respect of those purchases for processing a refund in respect of those purchases.

### BACKGROUND

The present invention relates to apparatus, systems and methods for obtaining tax refunds associated with purchases.

Tax refund systems are offered in many countries for travellers. Providing tax free shopping can be attractive to visitors to a country and can help to promote tourism. However, traditionally, the administration for tax free shopping schemes has been paper-based with merchants issuing vouchers or cheques at a point of sale, and then customs verifying the export of the goods at a border. Although regulations vary from country to country, the traditional format for providing tax free shopping is for a merchant in a country to identify and verify that a customer is a visiting traveller entitled to a tax refund, then to issue the voucher that includes details of the traveller and the purchased item, and then for customs to verify at the point of exit from the country that an item being exported and that the traveller corresponds to the item and traveller identified on the voucher. The refund can then be made. Tax refund operators act with merchants and customs to facilitate the operation of this process and to manage the paperwork associated therewith.

However, such a process is very labour and cost intensive. However, there are significant technical difficulties in ensuring that a tax refund system can operate efficiently, while at the same time being secure.

The present invention seeks to provide a technological solution to such problems.

### SUMMARY

Aspects of the invention are defined in the claims.

An embodiment can provide an apparatus comprising a validation station. The validation station can receive a token and can include a reader operable to read a machine readable user identifier that identifies the user. The validation station can transmit a validation request message that identifies the token to an approval system that holds or has access to transaction information identifying one or more purchases associated with the token in order to validate a tax refund for the one or more purchases, wherein eligibility of the user is derived from the machine readable identifier. The validation station can receive a response message from the approval system and to indicate to the user whether a refund associated with the one or more purchases has been validated.

An embodiment can provide an apparatus comprising an approval station. The approval station can receive a token and can include a reader operable to read a machine readable user identifier that identifies the user. The approval station can obtain information from an approval system that holds or has access to transaction information identifying one or more purchases associated with the token to validate a tax refund for the one or more purchases. The approval station can present to an official details of the one or more purchases and/or of the user associated with the identifier.

An embodiment can provide an apparatus comprising an approval system. The approval system can have access to storage for transaction information identifying one or more purchases associated with a token and/or rules defining eligibility for a tax refund. The approval system can respond to a validation request message that is received from a validation station and that identifies the token for a user to determine whether to validate a refund associated with the one or more purchases based on the token for the user and to transmit a validation response message.

An embodiment can provide an operator host system. The operator host system can include storage for storing transaction information identifying one or more purchases in association with a token and a merchant identifier. The operator host system can be responsive to transaction information that identifies one or more purchases associated with a token from a merchant system to store the transaction information identifying one or more purchases in association with the token and the merchant identifier. The operator host system can further be operable to transmit the transaction information identifying with one or more purchases associated with the token to an approval system.

An embodiment can provide a merchant system. The merchant system can receive a token identifying a user and/or details of one or more purchases. The merchant system can be operable to transmit a transaction message to an operator host system, the transaction message defining one or more purchases associated with a token and a merchant identifier.

An embodiment can provide a computer implemented method of processing a refund comprising: in response to a user making one or more purchases, recording transaction information representative of the one or more purchases associated with a token; and in order to validate a refund, a validation station receiving input of a machine readable user identifier and the token; and an approval system that holds or has access to the recorded transaction information determining whether to validate a tax refund based on the eligibility of the user identified by the machine readable identifier for a tax refund for the transaction information; the validation station indicating to the user whether a refund associated with the one or more purchases has been validated and in response to positive validation, effecting a refund.

An embodiment can provide a program product comprising program instructions for carrying out such a method.

Although various aspects of the invention are set out in the accompanying claims, other aspects of the invention include any combination of features from the described embodiments and/or the accompanying dependent claims with the features of the independent claims, and not solely the combinations explicitly set out in the accompanying claims.

### BRIEF DESCRIPTION OF THE DRAWINGS

Embodiments are described, by way of example only, with reference to the accompany drawings.

FIG. 1 is a schematic block diagram illustrating an example of a simple refund approach;

FIG. 2 is a schematic diagram of an example embodiment of a refund system according to an embodiment of the invention;

FIG. 3 is a schematic system overview;

FIGS. 4-7 form a flow diagram of an example method of operation.

### DETAILED DESCRIPTION

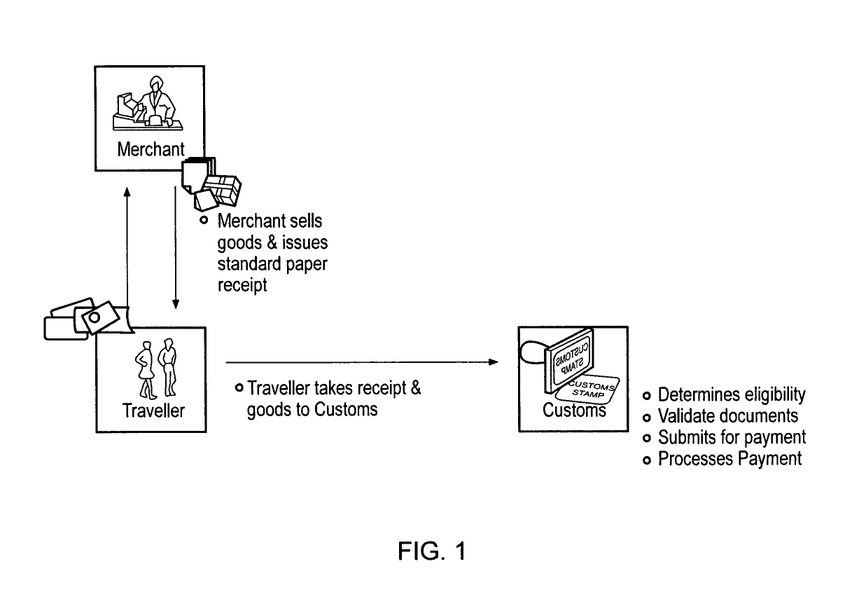

FIG. 1 illustrates a simple approach to obtaining a refund of tax associated with a purchase. The approach illustrated in FIG. 1 includes a traveller receiving a conventional store receipt from a merchant on making a purchase. The store receipt together with the goods is the presented to customs. Customs then determines eligibility and validates the store receipt. The tax authority then accepts the validated receipts, processes the tax refund, and makes payment to the traveller.

There are a number of disadvantages with such a system, both from a commercial and technical point of view. The merchant in such a system has no relationship with the traveller. Unless the traveller is already aware of his eligibility for a tax refund, there is no additional in-store activity to stimulate traveller sales. The traveller perception after a purchase if no refund is received is not positive and the number of non-refund eligible customers in this simple system is high. Also, a traveller is unable to claim a refund if the traveller forgets to obtain the necessary paperwork on departure.

Further, the tax authority is required to issue refund forms, collect completed forms and receipts, process the claims, and issue payments. The administration of keeping track of shop receipts with the traveller and with each shop is substantial and this is necessary to be able to have reconciled tax declarations from the merchants. Further, dispute resolution and enquiries from travellers and merchants must also be handled by the tax authority.

An example embodiment of the invention maintains simplicity of operation but addresses both the integrity and usability shortcomings of prior approaches. In the example embodiment one or more systems coordinate processing of purchases and refunds using one or more tokens that uniquely identify a user, for example a traveller. The one or more systems can be operated by a Tax Refund Operator (TRO).

As well as providing administration of the refund operations, the TRO can provide education for a traveller and merchants throughout the process. Through the use of information technology systems, the TRO can ensure the integrity of the system.

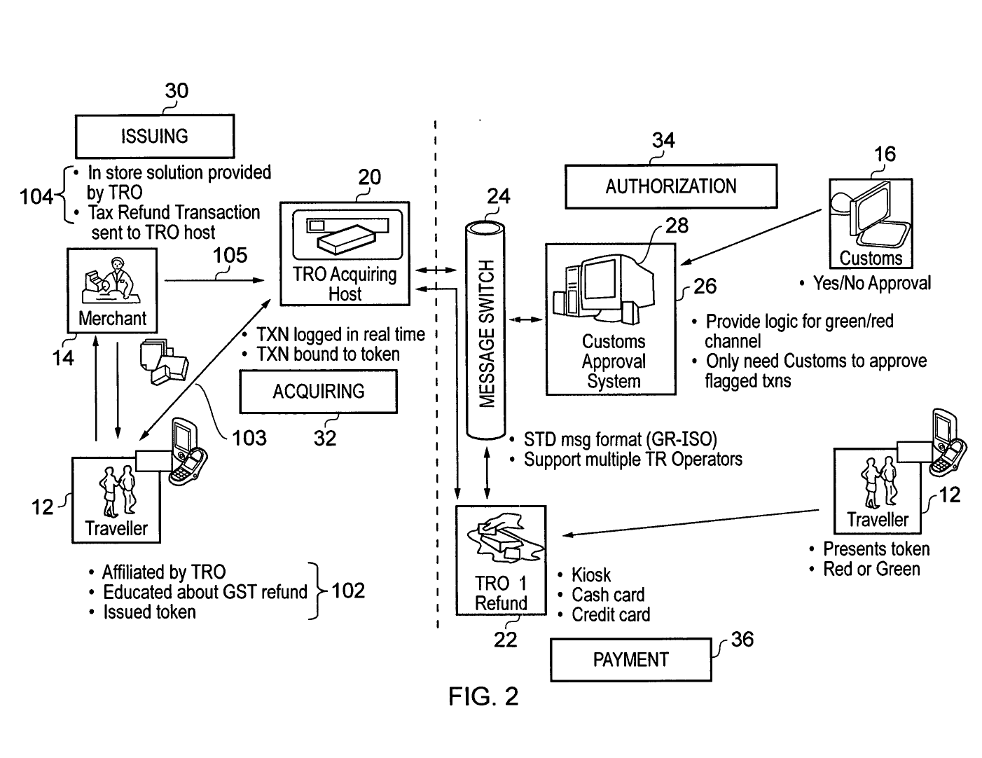

FIG. 2 illustrates example methods, apparatus and systems for managing a refund process. In the example process shopping and receiving of a receipt (issuing 30) is separated from further processing (acquiring 32, authorisation 34 and payment 36).

As with credit and debit cards, there can be multiple providers of issuing services, and multiple acquirers of transactions and processing. For example there can be multiple TROs. The issuing of transaction can follow a standard message type for transmission to an authorization and payment system. A wide range of point of sale (POS) devices and in-store support for traveller shopping can be provided.

In an example embodiment, a merchant system provides the issuing 30 of transactions using TRO provided POS devices and/or software, a TRO host system carries out the acquiring 32, a customs approval system carries out the authorization 34 and a TRO host system carries out the refund payment 36 using a kiosk (validation station) at a point of exit from the a territory. In an example embodiment, the determination of eligibility and identity is moved away from a point of sale to the point of exit from the territory. An example embodiment can provide the simplicity of use of the approach described with reference to FIG. 1 as perceived by the users of the system, while also providing enhanced integrity.

In a conventional approach, shop assistants and counter cashiers are expected to be able to verify eligibility for a tax refund by examining the passport of the traveller. In fact, many travellers are reluctant to carry their passports while out shopping, and so in practice shops permit the traveller to fill in such details that are required on refund vouchers after leaving the shop.

In contrast thereto, in an example embodiment, the user (e.g., a traveller) uses a token when making a purchase and the eligibility is determined at a point exit from the territory. By moving the determination of eligibility away from the point of sale, the dependence on people who are less well trained can be reduced, and eligibility can then be performed by properly equipped machines and resources.

Examples of possible tokens include a passport number, a passport, an identity card number, an identity card, a driver's licence number, a driver's licence, a payment card number, a payment card, a card refund operator card number, a card refund operator card, a visitor card number, a visitor card, a user defined identifier, a mobile phone, etc. As indicated, the token could be a visitor card or other visitor token that could be issued to the user, for example on entry to the territory, with or without checking of identity at this stage. The visitor token could, for example, be a chip card or a card with a magnetic stripe that would have a unique number.

By presenting the token when making a purchase, a record of the purchase can be made associated with the token. A computer record can be made of an association between the token and a transaction identifier (e.g. a sales receipt) for a purchase transaction for one or more purchases. The token can then be used subsequently to retrieve the record of the transaction(s) on exit from the territory to validate the refund on the purchases.

In the following a system and method of an example embodiment of a tax refund system for a territory is described with reference to FIG. 2 in which multiple TROs affiliate merchants, and then provide tax refunds to travellers through the user of a self-service kiosk 22 at an exit point from a territory.

In a first stage 102 a token is allocated to a user. This can be done before or at a point of entry to the territory or at a point of sale. In one example the user can choose the token to be used. For example the user could specify, for example via a website or at a point of sale terminal or in response to being asked by a merchant, a particular token to be used (e.g., a token of one of the types referenced above). For example, a user can register his/her details and associate his/her details with a token by registering on a web site provided by a TRO. The TRO can then provide information to the user about refund opportunities and processes. Alternatively, or in addition, the user could be issued with a token (for example a visitor card as mentioned above). User details can then be recorded in an input station local to the point of issue, for example at the point of entry or at a point of sale, or the issued token could be linked to user details pre-entered on the TRO website. A suitable input station can include, for example, a computer processor and memory, one or more input interfaces in the form of one or more of a keypad, a keyboard, a touch sensitive screen, a card reader, a machine readable identifier reader, a document scanner, a voice-activated input, and one or more output interfaces in the form of one or more of a display, a printer, a card writer, a speaker. The input station could also be provided with a finger print reading and/or camera technology for verifying biometric information held on a machine readable user identifier (e.g., an ID document such as a passport).

A token identifier (for example a number unique to the token along with details of the user (the traveller) can be provided 103 to and held at an acquiring host server system 20 where the identifier and the user details are recorded (stored). The host server system 20 can comprise one or more server computers, each comprising one or more processors and memory, located in a single place or in a distributed system. The efficiency of the system is enhanced where the identifier for the token and the details of the user are forwarded to the host server system and are recorded in real time.

In a next stage 104, the user 12 can make purchases, for example at a merchant. When presented with the normal shop receipt, the user 12 can be asked if a tax refund is required (or the user can ask for a tax refund). If a refund is desired, a second, simple transaction can be created by entering a receipt identifier (e.g. a receipt number), the value of the goods purchased, and the token identifier. Thus, in this example embodiment, information including three items (receipt identifier, value of purchase, token identifier) can then be electronically transmitted by a merchant system 14 to the acquiring server system 20. The merchant system 14 can comprise one or more computers, each comprising one or more processors and memory, located in a single place or in a distributed system.

As there can be multiple TROs in a market, there can be multiple acquiring system hosts 20. The relationship between a merchant and a TRO is that of merchant and acquirer (to use the credit/debit card example). Each TRO affiliates its own merchants and is responsible for the point of sale (POS) devices and integrated software that creates a tax refund transaction. The transaction message can therefore be transmitted 105 to the TRO acquiring host system 20 where further processing can be performed. The transaction message format between the POS and the acquiring host can take any appropriate form as this can be proprietary. In one example the transaction message transmitted between the merchant system 14 and the acquiring host 20 contains the token identifier (e.g., a token number), a receipt identifier (e.g. a receipt number), references to the goods purchased, a merchant identifier, a TRO identifier, a time and date stamp, and a security hash (which is used to prevent tampering). It may in addition contain information about a tour guide, promotional codes, or any other data that the TRO wishes to collect.

A separate acquiring host system 20 can be provided for each TRO, so that commercially sensitive information can be kept separate in that each TRO is only able to see transactions generated by its affiliated merchants. All tax refund transactions generated by affiliated merchants can be stored in the database of the acquiring host system 20. A transaction record as stored in memory of the acquiring host system can include, for example, a token identifier (e.g., a token number), a receipt identifier (e.g. a receipt number), references to the goods purchased, a merchant identifier and a time and date stamp. The acquiring host system 20 could also allocate a unique transaction identifier (e.g., a unique transaction number) to the transaction in order that a unique number is available within the system to track that transaction during processing.

A message switch 24 provides a neutral place for all messages to be received and transmitted, and to provide for messages to be properly formatted and routed. For example transaction messages can include one or more of a transaction identifier (e.g. a transaction number), a token identifier (e.g., a token number), a receipt identifier (e.g. a receipt number), references to the goods purchased, a merchant identifier, a TRO identifier, a time and date stamp, and a security hash (which is used to prevent tampering). The message switch 24 may be a separate system, or combined with a custom approval system 26 according to a particular implementation.

Transactions received by each of the acquiring host systems 20 can be forwarded through the message switch 24 to the customs approval system 26. The customs approval system can comprise one or more computers, each comprising one or more processors and memory.

A transaction message received by the TRO at the acquiring host system 20 can be formatted in accordance with a standard proposed (e.g., GR-ISO) and can be transmitted to a message switch 24. The message switch can be operable to pass a transaction message to a customs approval system 26.

The customs approval system 26 provides an authorisation system for authorising refunds, and can be run by a customs authority, or on its behalf by a third party. The customs approval system 26 is capable of approving or rejecting tax refund transactions automatically based on rules set in the system by customs. The customs approval system 26 can also be accessed manually by a customs officer.

Self-service validation stations (kiosks) 22 at the territory exit points can be connected to the message switch 24. A validation station 22 can be configured to invite a user to present an identifier (e.g., an identity document such as a passport) to be read. A validation station 22 can be provided with one or more input interfaces in the form, for example, of one or more of a keypad, a keyboard, a touch sensitive screen, a card reader, a scanner, a voice-activated input and one or more output interfaces in the form, for example, of one or more of a display, a printer, a card writer, a speaker. The validation station 22 could also be provided with a finger print reading and/or camera technology for verifying biometric information held on a machine readable user identifier (e.g., an ID document such as a passport).

In one example the validation station 22 can be configured to determine the eligibility of a user for a tax refund by machine reading the identifier. In this example the validation station 22 reads the information from the identifier and determines eligibility by checking the information against an internal database that contains information about domestic/non-eligible travellers. In this case, the user can be deemed eligible if his/her nationality or status is not on the list (negative approval). Alternatively, or in addition, the validation station 22 can be operable to determine eligibility by checking the information against an internal database that contains information about non-domestic/eligible travellers. In this case, the user can be deemed eligible if his/her nationality or status is on the list (positive approval).

As mentioned above, the validation station 22 could also be provided with a fingerprint scanner and/or a camera and can be used to verify the identity of a user using biometric information held on the machine readable identifier (e.g., the identity documents such as a passport). A discussion about such biometric information is to be found, for example, at the following Internet link: http://www.highprogrammer.com/alan/numbers/mrp.html.

Where eligibility of a user is determined at a validation station 22, then the validation station 22 can be operable to prompt the user to present a token. In the event that the user presents a token, then the validation station 22 can be operable to pass a one or more validation request messages through the message switch 24 to the customs approval system 26 custom approval system 26 requesting a list of all tax refund transactions from all TROs.

In another example, the validation station 22 can be configured to prompt a user to enter the user identifier and the token and then to pass a validation request message to a custom approval system to request approval based on both the eligibility of the user and the transactions recorded in association with the transactions. In this other example, the validation station 22 can transmit a validation request message that includes the information from the identifier and the token identifier, and the customs approval system can determine eligibility and whether to validate the transactions.

The customs approval system 26 can be operable to respond to a validation request message to retrieves all the transactions associated with the token from its own database and/or from the acquiring host systems 20, and can apply rules set to determine approval or rejection.

In one example, the customs approval system 26 could be set to either automatically approve the transactions based on rules that have been set, (“green channel”) or automatically to reject a transaction (“red channel”), again based on rules set within the customs approval system 26.

When the customs approval system 26 has made a decision about a transaction (approve/reject), an authorization message (validation request response message) is automatically routed through the message switch 24 back to the appropriate acquiring host system 20. The acquiring host system 20 updates an existing tax refund transaction record for the transaction with the authorization message (approve, reject, change).

A decision to pay a refund rests with the TRO as the TRO is responsible to the tax authority for the transaction. For that reason, the customs approval host does not act as the payment authorization host, but rather the TRO's acquiring host system 20 is the system of record.

Each acquiring host system 20 formats and transmits a refund message to the validation station indicating which transactions have been approved for “green channel” automatic payment. A TRO that issued the token is given first position on the Validation station, and that TRO's transactions are displayed.

If all the retrieved transactions have approved codes, the user is given “green channel” service and is asked how a refund is to be paid. If any of the transactions are not approved, the user is given “red channel” service and is asked to present himself to a customs officer for further processing.

If the choice of refund is payment card (e.g., a credit card), the refund can automatically made to the registered payment card. If no payment card is registered, the validation station can prompt the user to swipe a card to which the refund should be made.

If the user requests a cash equivalent refund and the user has used a TRO issued token that can store a cash amount, then the refund amount can be credited to the token.

If the user requests a cash equivalent refund and the user has not used a TRO-issued token, a stored-value card can be issued from the validation station 22.

The process set out above is repeated for each remaining TRO that has transactions associated with the token.

In the event that red channel processing is indicated, then the validation station prompts the user to presents the token and the identifier to a customs officer, who can then use the token to begin processing. A customs official can be provided with an approval station that is linked to or forms part of the customs approval system 26. However, in other examples, the approval stations can be separate from and/or remote form the customs approval system and can communicate therewith, for example via the message switch.

In response to input of the token identifier (e.g., where the token is a magnetic stripe card, by swiping the card), the approval station can be configured to use the token identifier to transmit an information retrieval message to the customs approval system 26, that can then retrieve a list of approved and rejected transactions associated with the token.

The customs officer can then approve or reject each transaction, or change the value amount. The customs officer can enter the result of his/her decisions using input device(s) of the approval station 28. The result of his/her decisions is communicated by the customs approval system 26 through the message switch 24 to the appropriate acquiring host system 20. The acquiring host system 20 now contains tax refund transactions with approval codes (approved, rejected, changed value).

The user can then return to the validation station 22, present his/her token once more and be prompted for the manner of the refund as discussed above.

The customs authorisation system 26 can be configured to operate in one or both of two modes of operation. In one mode of operation, information for transactions is stored on the respective acquiring host systems 20. In the first mode of operation, the customs approval system 26 is operable to retrieve transaction information from the respective acquiring host system 20 for validating refunds. The result of the authorisations is communicated back through the message switch 24 to the appropriate acquiring host system 20. The acquiring host system 20 now contains tax refund transactions with approval codes (approved, rejected, changed value). In the second mode of operation, the customs approval system retains a copy of each transaction within its own database, associated not only with the relevant token identifier, but also with an acquiring host system identifier. In this caser the customs approval system 26 also passes the transaction and approval code back to the acquiring host system 20 concerned. The difference between the two modes is that in the second mode, the CAS retains a copy of all data from all acquiring host systems 20.

Secure transmission, messages and protocols can be used for communicating information using existing software, equipment, and processes for handling secure financial transactions as known for electronic payments. A standards-based message format can thus be used for transmitting refund transactions. The use of standard message format can allow for multiple TRO providers, while ensuring that customs and inland revenue services only have to deal with a single system for approvals.

By recording transactions on the acquiring host system 20 and/or on a customs approval system 26 using the transaction identifier, value of purchase and token identifier, and by further maintaining the user detail records linked to the token identifier in the acquiring host system, a customs approval system 26 can be operable to retrieve refund transactions from the acquiring host system 20 of a TRO based on the presentation of a token, to indicate a “yes/no” response to a request for permission to refund, and to transmit that result to the acquiring host system 20.

In the illustrated example communication between the acquiring host system(s) 20 and the customs approval system 26 can be effected by a message switch 24. The message switch 24 can provide a dedicated network between the customs approval system 26 and the acquiring host systems 20 for one or more TROs. Rather than a dedicated network, the communication can be made via secure switching channels operating over a public network such as the Internet.

In an example embodiment, automated validation stations (kiosks) 22 can be provided that allow automatic pre-screening of refund transactions to generate a “red channel/green channel” response without human intervention. The automatic pre-screening process could be effected using, for example a validation station 22 (e.g., a kiosk) at an exit point form the territory.

The validation station 22, or an approval system (e.g. the customs approval system 26) in communication with the validation station 22, could be provided with rules defining a “red channel” requirement, for example for high-value purchases and/or for purchases of a particular type. The “red channel” behaviour could be to require a user to present a token, shopping receipt, passport, and the goods purchased to a Customs Officer for approval.

The validation station 22, or the approval system 26 in communication with the validation station, could be provided with rules defining a “green channel” situation providing automatic approval for low value items and/or for purchases by travellers from particular countries, and so on.

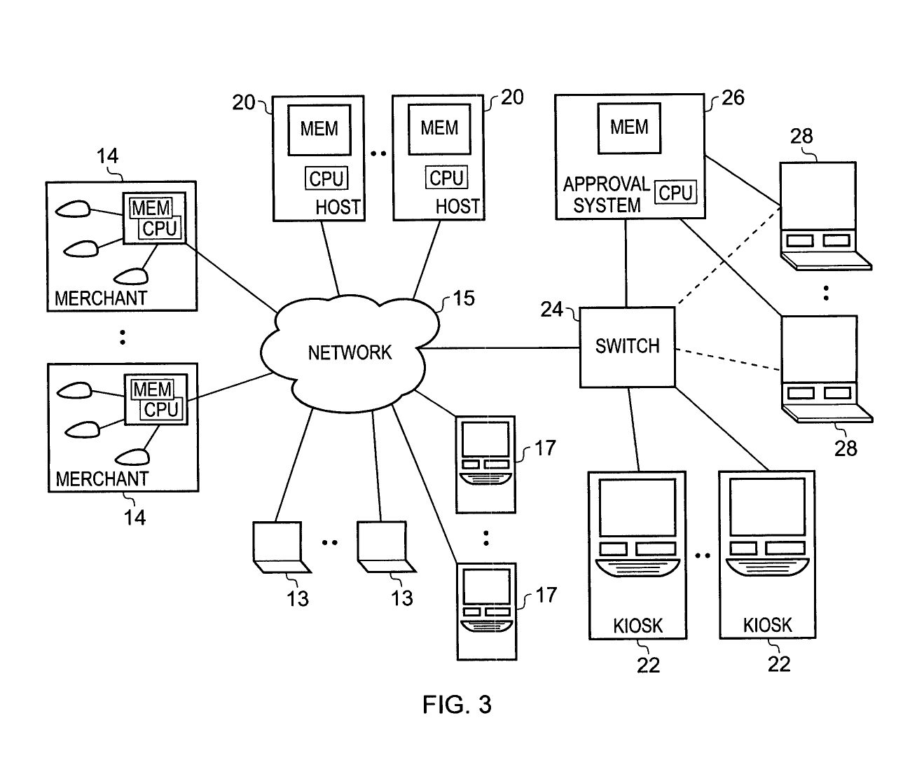

FIG. 3 is a schematic system diagram giving an overview of an example overall system configuration of an example embodiment.

FIG. 3 illustrates various systems connected via a network 15, for example the Internet.

FIG. 3 illustrates a plurality of user computers 13 (e.g. a desktop, laptop, personal data assistant, mobile telephone, etc) connected to the network 15. A user computer 13 can be used by a user (e.g., a traveller) to access a website to register a token. The website can be provided by one of a plurality of TROs, a tourist or travel organisation or authority, by way of example only.

FIG. 3 illustrates a plurality of input stations 17 connected to the network 15. An input station 17 can be provided, for example, at a point of entry (e.g. an airport immigration area), a tourist office, a retailer etc. An input station 17 can be provided with one or more input interfaces in the form, for example, of one or more of a keypad, a keyboard, a touch sensitive screen, a passport or other ID document reader, a card reader, a scanner, a voice-activated input and one or more output interfaces in the form, for example, of one or more of a display, a printer, a card writer and/or dispenser, a speaker. In an example embodiment the input station can be operable to issue a token, for example a card with a unique identifier.

FIG. 3 illustrates a plurality of merchant systems 14 connected to the network 15. Each merchant system 14 can involve one or more computer systems, each comprising one or more processors and memory, and one or more point of sale devices, that can include one or more input interfaces in the form, for example, of one or more of a keypad, a keyboard, a touch sensitive screen, a card reader, a scanner, a voice-activated input and one or more output interfaces in the form, for example, of one or more of a display, a printer, a card writer, a speaker.

FIG. 3 illustrates a plurality of TRO acquiring host systems 20 connected to the network 15. Each acquiring host system can involve one or more computer systems, each comprising one or more processors and memory.

FIG. 3 illustrates a message switch 24 connected to the network 15. In this example the message switch 24 acts as a communications interface between the acquiring host systems 20, validation stations and a customs approval system 26.

FIG. 3 illustrates a plurality of validation stations 22 connected to the network 15. A validation station 22 can be located at a point of exit (e.g. an airport departure area). A validation station 22 can be provided with one or more input interfaces in the form, for example, of one or more of a keypad, a keyboard, a touch sensitive screen, a passport or other ID document reader, a card reader, a scanner, a voice-activated input and one or more output interfaces in the form, for example, of one or more of a display, a printer, a card writer and/or dispenser, a speaker. The validation station could also be provided with one or more devices for inputting user biometric information, such as a finger print scanner or a camera.

The familiarity of users with automated teller machines and the like means that validation stations in the form of self-service kiosks at the exit points are acceptable to users.

As described above, in one example, the validation station 22 can be provided with a reader for automatically reading machine readable identifiers (e.g. machine readable identification documents such machine readable passports and can thereby enable automatic verification of the identity and eligibility of the user for a refund. The validation station 22 can prompt the user to present the token identifier. As also indicated above, the token is could be in the form of a magnetic stripe card, a chip card, a bar code, a number that has to be entered at a key pad, etc.

The validation station can then determine eligibility for a refund based on information held in a customs approval system or a TRO acquiring host system defining one or more purchases associated with the identifier, in order to determine whether to validate a refund associated with the one or more purchases. Optionally the validation station 22 could receive biometric information and cross check this against information held on the machine readable identifier to verify the identity of a user.

In one example the validation station can respond to input of the token identifier to transmit a request to the server for information defining one or more purchases associated with the identifier, to compare information received from the server defining one or more purchases associated with the identifier to pre-defined rules to determine whether to validate a refund and to cause the output interface to indicate to the user whether the refund has been validated automatically (i.e. whether the validation is effected automatically). Where the refund is validated, the validation station can transmit to the server confirmation that validation has been effected for the refund to be effected.

In another example, the validation station can respond to input of the token identifier to transmit a request to the server to determine whether to validate a refund and to be respond to a response from the server indicative of whether a refund for the one or more purchases has been validated to cause the output interface to indicate to the user whether the refund has been validated (i.e. whether the validation is effected automatically).

Alternatively, the user can be prompted to report to a manual validation check by a customs officer.

The validation station can also be operative to prompt the user to identify the refund should be made (for example to a credit card or with cash). If the user selects credit card, the transaction can automatically be refunded. If the user selects cash, then the user can be issued a fully active debit card with the refund amount, or be prompted to go to a place airside to receive the cash.

If a “red channel” response is the result, the user can be prompted to indicate how a refund is to be made if approved, and the user can then be directed to a Customs desk for further checking.

At the customs desk, a customs office can use an approval station to retrieve the information for the server system using the token identifier.

An approval station can be provided with one or more input interfaces in the form, for example, of one or more of a keypad, a keyboard, a touch sensitive screen, a card reader, a scanner, a voice-activated input and with one or more output interfaces in the form, for example, of one or more of a display, a printer, a card writer, a speaker.

Using the token identifier, the customs officer can call up the transaction information form the server system, inspect the documents and goods, and decide whether to approve or reject the refund.

If the refund is approved, and the user had requested a credit card refund, the credit card transfer could then be effected automatically in response to the customs officer approving the refund using the approval station. Alternatively, a debit card could be generated by the approval station, or by the validation station.

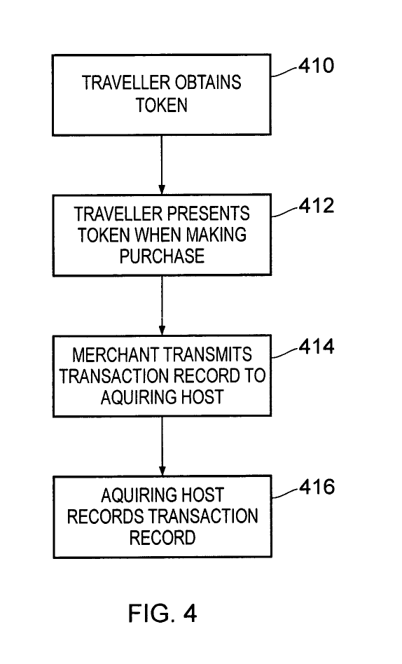

FIGS. 4-7 provide a flow diagram giving an overview of the operation of a system as illustrated in FIGS. 2 and 3.

At 410 (FIG. 4), a user obtains a token. For example the user can specify a token or can be issued with a token as described above.

At 412, the traveller presents the token when making a purchase.

At 414, the merchant transmits a transaction record to an acquiring host system of a TRO that has provided the merchant with the POS devices and/or software. In an example embodiment this is done in real time using a message that includes a token identifier, a receipt identifier and an amount of the transaction.

At 416 the acquiring host stores the transaction record to include the token identifier, the receipt identifier and the amount of the transaction.

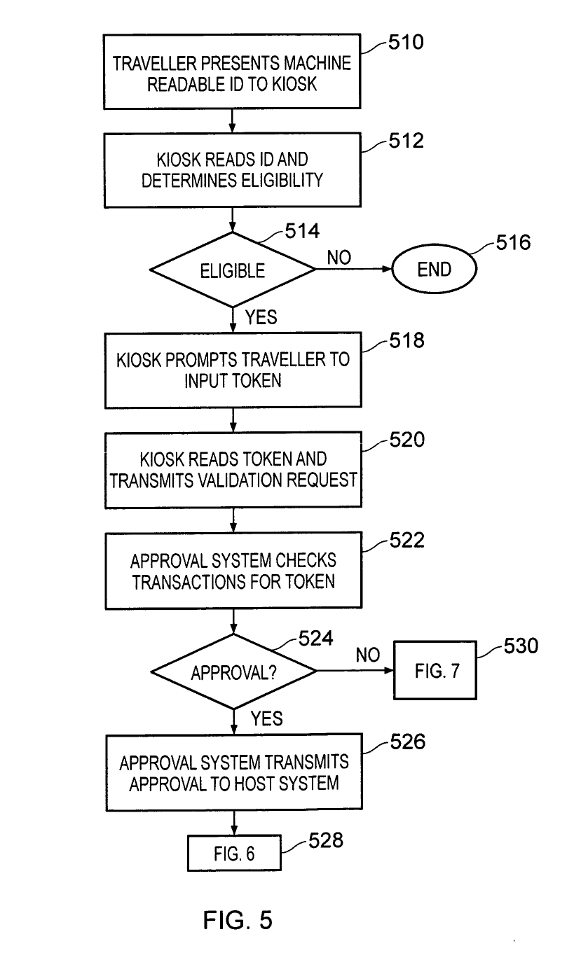

Turning now to FIG. 5, on leaving the territory, at 510 the user presents a machine readable ID (e.g., a passport) to an ID reader of a validation station (a kiosk) at a point of exit from the territory.

In this example, at 512, the kiosk determines the eligibility of a refund for the traveller based on stored information and on the identity of user derived from the machine readable ID. Optionally, the kiosk could also verify the identity of the user by using biometric data held on the machine readable ID (e.g. a finger print or iris pattern).

At 514, if the user is not eligible, then the user will be provided with an appropriate message at the kiosk and the process ends at 516—for example the user could be referred to a customs desk for manual processing.

Alternatively, if eligibility is detected, then at 518 the user can be invited to present the token.

At 520, the kiosk can read the token (e.g., using a card reader is the token is a card) and can transmit a validation request to the customs approval system including a token identifier.

At 522, the approval system can check the transactions (available in the approval system and/or from an acquiring host system as appropriate) using the token identifier to retrieve relevant transactions.

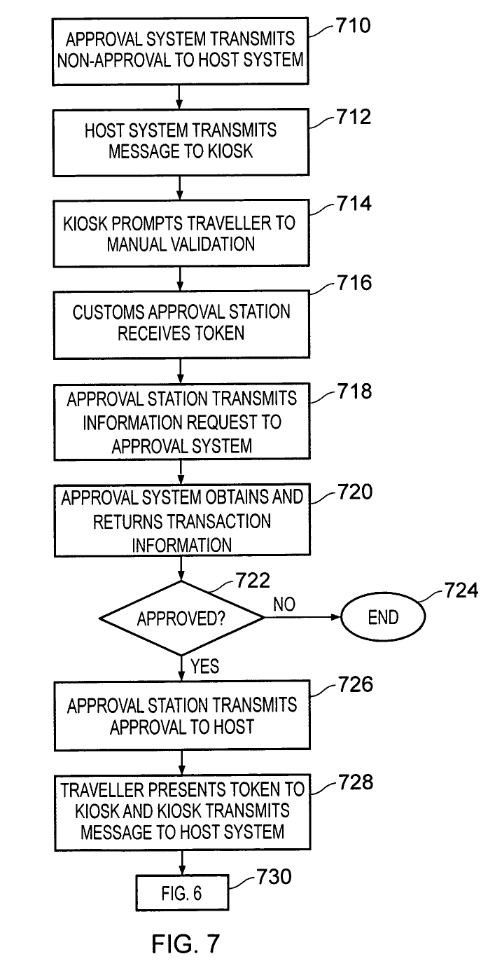

If, at 524 approval is not given automatically, then the further processing is described with reference to FIG. 7.

Alternatively, if at 524 approval is given automatically, then the approval system can transmit an approval message to the respective acquiring host system for each approved transaction.

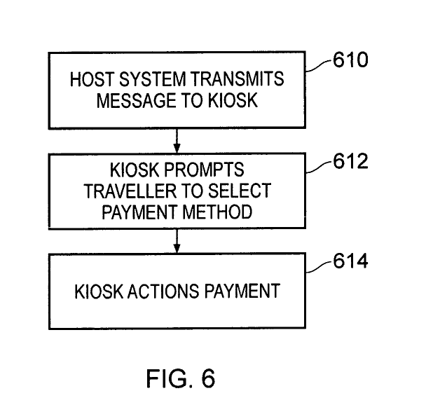

Turning to FIG. 6, for each acquiring host system that received an approval message from the approval system, the acquiring host system can transmit an appropriate approval message at 610 to the kiosk.

At 612, the kiosk can prompt the user to select a payment method.

At 614, the kiosk can action the payment, for example by inviting the user to enter a payment to which a refund is to be credited, or by dispensing a card having a cash amount thereon.

Turning to FIG. 7, where approval is not given automatically at 524, then the approval system can transmit at 710 a non-approval message to the respective acquiring host system for each approved transaction.

At 712, an acquiring host system receiving such a non-approval message transmits an appropriate non-approval message to the kiosk.

At 714, if the kiosk receives a non-approval message, it can prompt the traveller to report to customs for a manual validation check.

At 716, a customs officer can receive the token from the user or can invite the user to enter the token at a customs approval station.

At 718, the approval station transmits an information request to the approval system including a token identifier.

At 720, the approval system obtains transaction information (available in the approval system and/or from an acquiring host system as appropriate) using the token identifier to identify relevant transactions and returns the transaction information.

If, at 722, the customs officer approves a transaction then the process terminates at 724 with the user (traveller) being told that the transaction is not approved by the customs officer, and by a message being returned from the approval station to the approval system and the acquiring host concerned that approval for a refund in respect of a given transaction is not given.

Alternatively, if at 722 approval is given for a refund, then at 726 the approval station transmits an appropriate message via the approval system to the relevant acquiring host system that approval for given transactions is given.

At 728 the user can present the token to the kiosk and a refund message can be sent to the acquiring host for transactions associated with the token.

As indicated at 730, the further processing to effect the refund can proceed as indicated in FIG. 6 is steps 610-614.

A refund system provides for detections of eligibility of a user for a refund and uses a token to identify purchases and to retrieve the information in respect of those purchases for processing a refund in respect of those purchases.

By providing an integrated system with information available from a server system, in combination with the use of a token identifier, purchases can be associated with a traveller and eligibility can be determined at a point of exit following the purchase transactions.

In an example embodiment the identity and eligibility verification is effected away from a shop. In an example embodiment this is done at the exit point. Additionally this can be done at an entry point. An embodiment enables this to be achieved through the use of the integrated network approach and the use of the token identifier.

An embodiment may be embodied in a computer program product for operating one or more processors. The computer program product may be in the form of a computer program on a carrier medium. The carrier medium could be a storage medium such as a solid state, magnetic, optical, magneto-optical or other storage medium. The carrier medium could be a transmission medium such as broadcast, telephonic, computer network, wired, wireless, electrical, electromagnetic optical or any other transmission medium.

It should be noted that the term “payment card” as used herein is used in a generic manner to describe a token or device or carrier that can used to effect a transaction based on an account associated therewith. It should be noted that the “payment card” does not need to take form of a conventional rectangular plastic credit card or the like, possible with an integrated chip integrated therein, but the “payment card”, within the meaning applied herein, may take any other form that can be operable as a credit, debit, or other form of payment token, device or carrier. For example, within the meaning of the term “payment card” as used herein, a payment system could be based on, or permit the use of mobile telephones, personal data assistants (PDAs), or other carriers of information as the “payment card”. A mobile telephone configured as a payment card can include, for example, circuitry or software having functionality equivalent to that of a chip in an chip-based payment card. Accordingly, where reference is herein to a payment card, it is to be understood that that the “payment card” can take any suitable form to be operable as a payment token, device or carrier that is configured to conduct transactions based on an account associated therewith, for example means of appropriate software and/or a mechanism for transferring information to and from a payment terminal system (for example via contacts or in a contactless manner).

Although the embodiments described above have been described in detail, numerous variations and modifications will become apparent to those skilled in the art once the above disclosure is fully appreciated. It is intended that the following claims be interpreted to include all such variations and modifications and their equivalents.

1-37. (canceled)

38. An apparatus comprising a validation station having:
validation station input means configured to receive a token, the input means comprising a reader operable to read a machine readable user identifier that identifies the user;
validation station processing means configured to transmit a validation request message that identifies the token to an approval system that holds or has access to transaction information identifying one or more purchases associated with the token to validate a tax refund for the one or more purchases for an eligible user, eligibility being derived from information from the machine readable identifier;
validation station output means, the validation station processing means further being configured to receive a response message from the approval system and to indicate to the user whether a refund associated with the one or more purchases has been validated.

39. The apparatus of claim 38, wherein the validation station processing means is operable to determine the eligibility of the user to receive a refund by comparing information from the machine readable identifier to information stored in the validation station.

40. The apparatus of claim 39, wherein the validation station processing means is operable to obtain a token identifier in response to determining eligibility of the user to receive a refund from comparing information from the machine readable identifier to information stored in the validation station.

41. The apparatus of claim 38, wherein the validation station processing means is responsive to a first response message to indicate to the user that a refund associated with the one or more purchases has been validated automatically, and the validation station processing means is responsive to a second response message to refer to the user to a manual validation check.

42. The apparatus of claim 38, wherein:
the validation station input means further comprises one or more of a keypad, a keyboard, a touch sensitive screen, a card reader, a reader for a machine readable identifier, a scanner, a voice-activated input, a camera, biometric information capture apparatus; and
the validation station output interface comprises one or more of a display, a printer, a card writer, a speaker.

43. An apparatus comprising an approval station having:
approval station input means configured to receive a token, the input means comprising a reader operable to read a machine readable user identifier that identifies the user;
approval station processing means configured to obtain information from an approval system that holds or has access to transaction information identifying one or more purchases associated with the token;
an output interface configured to present to an official details of the one or more purchases and/or of the user associated with the identifier.

44. The apparatus of claim 43, wherein the approval station is responsive to the official validating a refund associated with the one or more purchases to transmit a confirmation message to at least one of the approval system or a host system that validation has been effected for the refund to be effected.

45. An apparatus comprising an approval system, the approval system having:
access to storage for transaction information identifying one or more purchases associated with a token;
approval system storage for rules defining eligibility for a tax refund;
approval system processing means operable in response to a validation request message that is received from a validation station and that identifies the token and a user to determine whether to validate a refund associated with the one or more purchases based on the token for the user and to transmit a validation response message.

46. The apparatus of claim 45, wherein the approval system processing means is operable to transmit the validation response message to an operator host system that maintains a relationship between the token and the user.

47. The apparatus of claim 45, wherein the approval system processing means is operable to transmit a first validation response message where a refund associated with the one or more purchases has been validated automatically, and to transmit a second response validation message where a refund has not been authorised automatically and the user is to be referred to a manual validation check.

48. The apparatus of claim 45, wherein the approval system processing means is further operable, in response to an information request from an approval station that identifies the token, to provide to the approval station transaction information identifying one or more purchases associated with the token.

49. The apparatus of claim 45, wherein the transaction information identifying one or more purchases associated with a token is stored in the approval system storage means.

50. The apparatus of claim 45, wherein the transaction information identifying the one or more purchases is stored in an operator host system.

51. An apparatus comprising an operator host system having:
storage for storing transaction information identifying one or more purchases in association with a token and a merchant identifier; and
processing means responsive to transaction information that identifies one or more purchases associated with a token from a merchant system to store the transaction information identifying one or more purchases in association with the token and the merchant identifier, the processing means being further operable to transmit the transaction information identifying with one or more purchases associated with the token to an approval system.

52. An apparatus comprising a merchant system having:
merchant system input means configured to receive a token identifying a user and/or details of one or more purchases,
merchant system processing means operable to transmit a transaction message to an operator host system, the transaction message defining one or more purchases associated with a token and a merchant identifier.

53. A computer implemented method of processing a refund comprising:
in response to a user making one or more purchases, recording transaction information representative of the one or more purchases associated with a token; and
in order to validate a refund, a validation station receiving input of a machine readable user identifier and the token; and
an approval system that holds or has access to the recorded transaction information determining whether to validate a tax refund for the one or more purchases for an eligible user, eligibility being determined from information from the machine readable identifier;
the validation station indicating to the user whether a refund associated with the one or more purchases has been validated and in response to positive validation, effecting a refund.

54. The method of claim 53, comprising validation station determining eligibility by comparing information read from the machine readable user identifier to information stored in or accessible to the validation station.

55. The method of claim 53, wherein
the validation station, in response to receipt of the token and the machine readable user identifier, transmits a validation request message that identifies the token and the user to the approval system.

56. The method of claim 53, wherein a first response message from the approval system represents that a refund associated with the one or more purchases has been validated automatically, and a second response message indicates that the user is referred to a manual validation check.

57. The method of claim 56, wherein, for a manual validation check, an approval station is responsive to input of the token and the machine readable user identifier to transmit an information request message to the approval system to retrieve information to determine eligibility for a tax refund for the one or more purchases and is operable to display the retrieved information to an official.

58. The method of claim 57, wherein the approval station is responsive to the official validating a refund associated with the one or more purchases to transmit a confirmation message to at least one of the approval system or a host system that validation has been effected for the refund to be effected.

59. The method of claim 386, wherein the approval system determines, on the basis of pre-defined rules, whether to validate a refund associated with the one or more purchases based on the token and the identity of the user.

60. The method of claim 53, wherein the approval system stores the transaction information.

61. The method of claim 53, wherein the approval system accesses the transaction information from an operator host system.

62. The method of claim 53, wherein an operator host system stores transaction information identifying one or more purchases in association with a token and merchant identifiers.

63. The method of claim 53, wherein the transaction information identifying one or more purchase transactions and the token is input at a merchant system, the merchant system transmitting a transaction message to an operator host system.

64. The method of claim 53, employing real-time messaging.

65. The method of claim 53, wherein the machine readable identifier one of a passport, an identity card, a drivers licence, a travel document.

66. The method of claim 53, wherein the token is one of a passport number, a passport, an identity card number, an identity card, a drivers licence number, a drivers licence, a payment card number, a payment card, a card refund operator card number, a card refund operator card, a visitor card number, a visitor card, a user defined identifier.

67. The method of claim 53, wherein the information identifying one or more purchases associated with the token comprises a transaction identifier.
